(19) United States
(12) Patent Application Publication
(10) Pub. No.: US 2016/0369950 A1
(43) Pub. Date: Dec. 22, 2016

(54) TUBE-STYLE LIGHT BULB HAVING LIGHT EMITTING DIODES

(71) Applicant: Jason Arlen Yeager, Overland Park, KS (US)

(72) Inventor: Jason Arlen Yeager, Overland Park, KS (US)

(21) Appl. No.: 14/744,301

(22) Filed: Jun. 19, 2015

(51) Int. Cl. F21K 99/00; F21V 17/10; F21V 23/00; F21V 3/02; F21V 23/06

(52) U.S. Cl. CPC F21K 9/175; F21V 3/02; F21V 23/06; F21V 23/002; F21V 23/009; F21V 17/104; F21Y 2103/003

(57) ABSTRACT

The present invention is directed to a light bulb having light emitting diodes that may be mounted in recessed double contact light bulb sockets. The bulb includes an elongated structure for supporting the light emitting diodes and a tubular shell surrounding the structure. The bulb also comprises an endcap having a socket for receiving a power supply plug. The invention may include a voltage regulator for regulating the voltage of the electricity powering the light emitting diodes.

### FIELD

The present invention relates to light bulbs. More specifically, a tube-style light bulb having light emitting diodes that may be secured to a conventional recessed double contact fluorescent light bulb socket.

### BACKGROUND

Various technologies exist for electric lamps or light bulbs. Fluorescent bulbs are popular because they are relatively inexpensive and may be used in many different applications. A typical fluorescent bulb comprises argon gas and mercury sealed within a cylindrical glass tube that has an interior coating of phosphor. When the bulb is powered, the argon and mercury are electrified and create ultraviolet light, which excites the phosphor coating to produce visible light.

Tube type fluorescent bulbs are commonly used in cabinet signs such as those on or near building exteriors. Cabinet signs usually employ recessed double contact (RDC) or R17d light bulb sockets to hold fluorescent tube bulbs in place. An RDC socket comprises a protrusion that engages with a cavity formed in an end of the bulb to securely hold the bulb in place. The protrusion has outwardly biased electrical contacts positioned on opposing sides of the protrusion. When the protrusion is inserted into the bulb cavity, the contacts engage the electrical receptors on the bulb to deliver electricity to the bulb.

Fluorescent bulbs are popular but they do have drawbacks. For example, because the mercury in the bulb is hazardous to the environment, the bulbs usually have to be recycled instead of disposed of in the trash. Also, while fluorescent bulbs have a relatively long lifespan compared to older lighting technologies such as incandescent bulbs, they do not last as long as newer technologies like light emitting diodes (LEDs). Fluorescent bulbs also tend to flicker which can be annoying to some people. What is needed in the industry is a light bulb without these problems that may be used to replace fluorescent bulbs. The replacement bulb should be able to be installed in an existing RDC socket.

General Electric has designed a product, the LineFit LED system, to replace fluorescent bulbs in cabinet signs. However, the product has a number of shortcomings. First, its bulbs must be hardwired to receive power. This requires using wire nuts or the like which makes replacing the lights arduous and time consuming. Also, the amount of light produced by the system is limited because LEDs are attached to only two sides of each bulb. Finally, the LEDs for each bulb are not covered by a shell, thus resulting in “hotspots” or an undesirable pattern of bright spots on the bulb. The present invention is a suitable replacement for fluorescent bulbs using RDC sockets and it does not have any of the shortcomings of the LineFit system.

### SUMMARY

The present invention comprises a light bulb having an elongated internal structure with a plurality of light emitting diodes secured thereto. The light emitting diodes are usually arranged in a linear fashion. The elongated internal structure is positioned at least partially inside a translucent tubular shell having a generally circular or curved wall. The bulb comprises at least one endcap having a pair of electrical conductors extending into a socket formed in the endcap. There may be a pair of electrical leads attached to the electrical conductors to transfer electricity to the light emitting diodes. The socket formed in the endcap is configured to receive a power supply plug. The bulb may also include a voltage regulator for regulating the voltage of the electricity being supplied to the light emitting diode.

The body of the endcap may be cylindrical and comprise a first cylindrical segment adjacent a second cylindrical segment. Each segment may include an annular or generally circular wall encircling a hollow interior cavity. The first cylindrical segment may be larger in diameter than the second cylindrical segment. The first and second segments may be shapes other than cylindrical and the walls may be shapes other than circular. The endcap may include a groove for receiving an end of the tubular shell between the interior cavity and annular wall of the first segment. The aforementioned electrical conductors and socket may be located in the second segment of the endcap. The endcap may also have a support member extending away from the body of the endcap that is adapted to engage a recessed double contact light bulb socket. The support member may include a rectangular recess formed in the distal end of the member for receiving a protrusion from the socket.

### BRIEF DESCRIPTION OF THE DRAWINGS

FIG. 1 is a perspective view of a light bulb installed in a lighted cabinet sign.

FIG. 2 is an exploded perspective view of the light bulb shown in FIG. 1.

FIG. 3 is a cross-sectional view of the light bulb taken along line 3-3 of FIG. 1.

FIG. 4 is a cross-sectional view of an endcap taken along line 4-4 of FIG. 1.

FIG. 5 is a cross-section view of an alternate embodiment of the light bulb similar to FIG. 3.

FIG. 6 is an exploded perspective view of a bulb aligned with a light socket.

FIG. 7 is a diagrammatic view of the wiring of the light bulb showing how multiple bulbs may be interconnected.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” “leftwardly,” “upper,” and “lower” will refer to the position (as shown in the drawings) of the item to which the reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

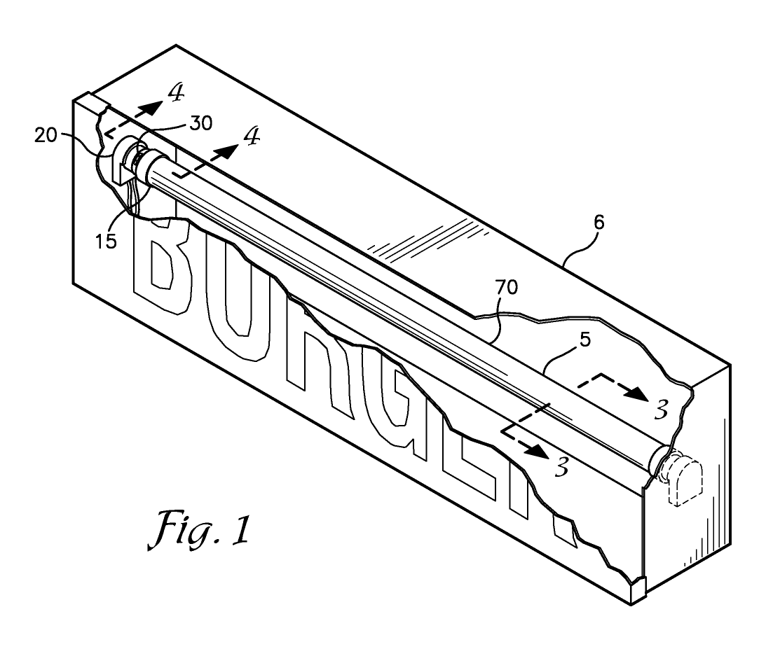

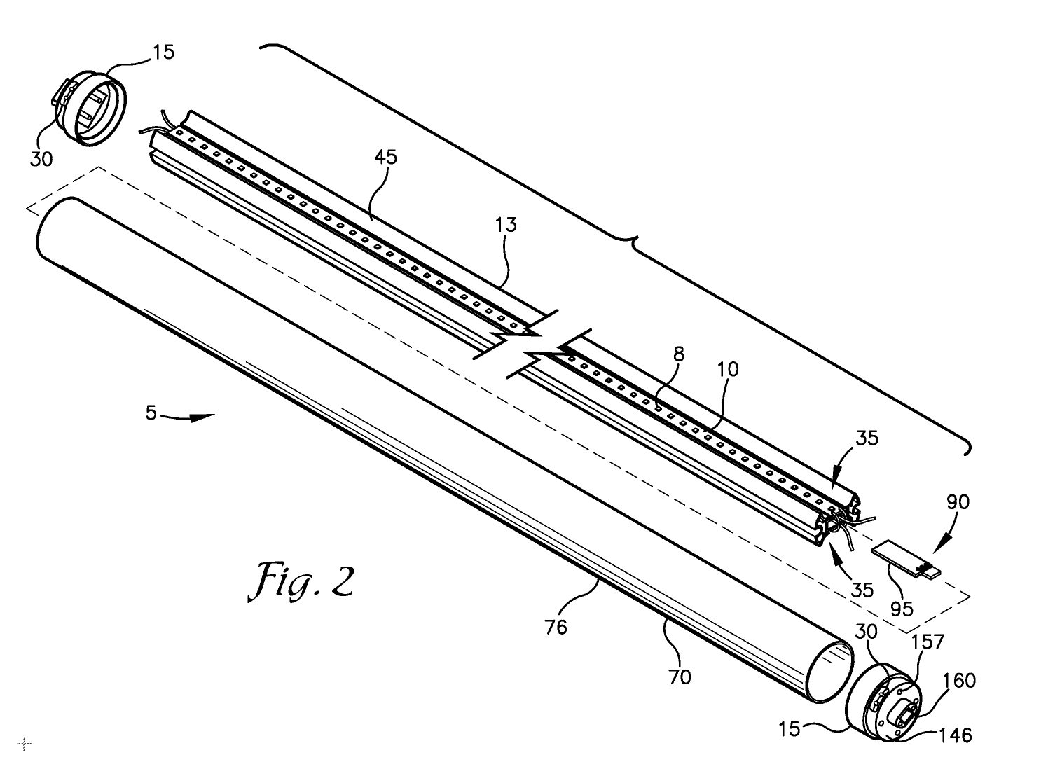

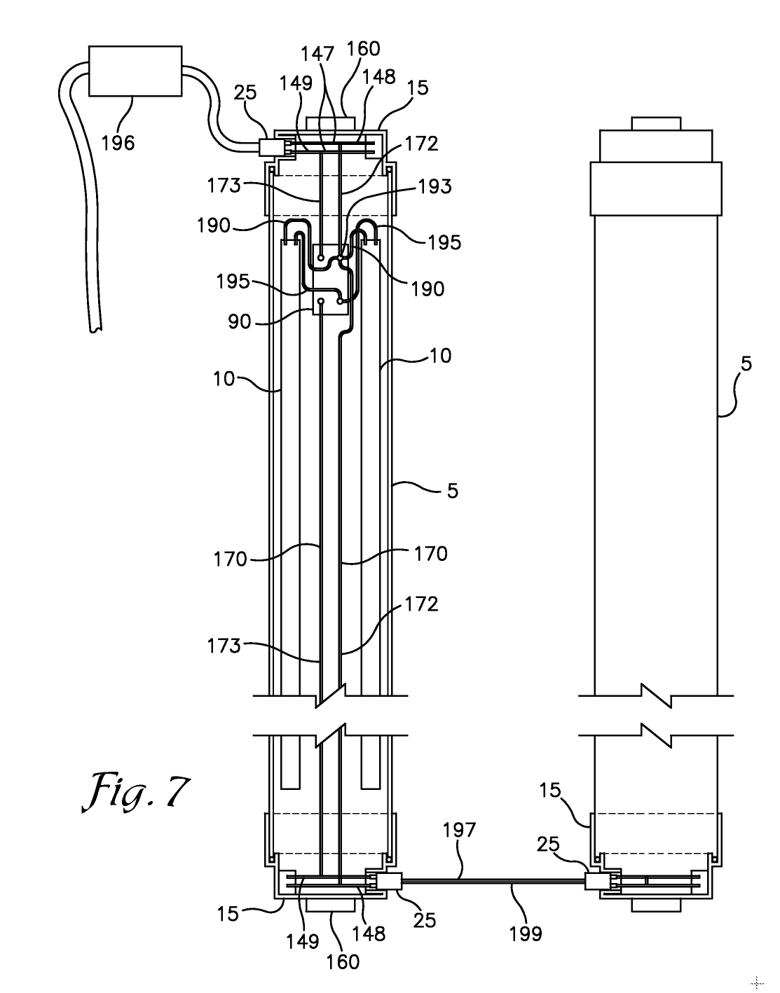

Referring to the drawings in more detail, FIGS. 1 and 2 show a tube style light bulb 5 installed in cabinet sign 6. Light bulb 5 comprises a plurality of light emitting diodes (LEDs) 8 on an LED strip 10, which is mounted on an elongated internal structure 13. An LED strip 10 may be mounted on multiple sides of structure 13 depending on the amount of light needed from bulb 5. The endcaps 15 located on each end of bulb 5 are shaped so that the bulb 5 may be received by recessed double contact (RDC) light sockets 20 like a conventional fluorescent light bulb. Although light bulb 5 may be received by RDC sockets 20, the bulb does not receive electrical power from the sockets. Light bulb 5 receives electrical power through a power plug 25 that engages a power socket 30 formed in a wall of endcap 15 (see FIG. 7). This method of delivering electrical power allows multiple bulbs 5 to be wired together to receive power from a single power source rather than each light bulb 5 being individually powered from its own light sockets. Using a plug to provide electricity is also preferable to hardwiring because there are no tools required to replace a bulb 5. Light bulb 5 is an easy and convenient replacement for fluorescent bulbs mounted in RDC sockets because there is no need to modify the existing light sockets or electrical wiring.

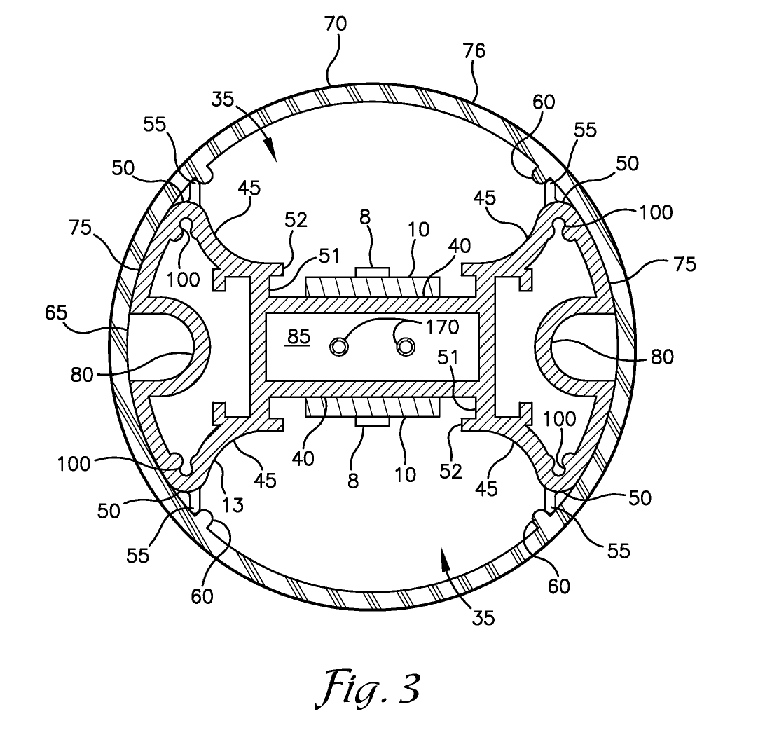

Referring to FIGS. 2 and 3, LED strip 10 comprises a plurality of LEDs 8 attached to the strip in a linear fashion. LED strips 10 are common in the industry and various types may be used. LED strips powered by 24 volts or less are preferable. Structure 13 is a linear member made of a rigid and relatively lightweight material such as aluminum. Aluminum is particularly well suited for structure 13 because of its heat transfer properties, which allows heat from LED strips 10 to be efficiently dissipated. Structure 13 may be created by extruding aluminum to form an elongated linear member having a cross section that is uniform for the entire length of the member.

Structure 13 has two channels 35 formed on opposite sides of the structure that run its entire length. Each channel 35 includes a flat trough 40 where LED strips 10 are mounted. Channel 35 also includes sloped walls 45 on each side of trough 40 which project outwardly from trough 40 to outer corners 50. At the base of each sloped wall 45 is a longitudinal rail 51 having a catch 52 protruding inwardly to engage and hold larger LED strips 10 if necessary. Adhesive may be used to secure an LED strip 10 to trough 40. Depending on the size of LED strip 10, the strip could also be secured in trough 40 using rail 51 and catch 52 without using adhesive.

Each outer corner 50 includes a ridge 55 that, when bulb 5 is fully assembled, engages a corresponding projection 60 on the inner surface 65 of the wall of translucent tubular shell 70. Structure 13 also includes two arcuate outer walls 75, each of which bows outwardly to approximate the radius of curvature of the wall 76 of shell 70. Each outer wall 75 spans from an outer corner 50 associated with one channel 35 to a corresponding outer corner 50 associated with the channel 35 on the opposite side of structure 13. Each outer wall 75 has a groove 80 that runs the length of wall 75 near the longitudinal midpoint of the wall. Groove 80 allows easier sliding of structure 13 in and out of shell 70 by minimizing the amount of surface area of outer wall 75 that contacts shell 70 during the sliding process.

As best seen in FIG. 3, structure 13 has several voids or cavities extending the length of structure 13. These cavities help to reduce the weight of structure 13 as well as allowing the heat given off by the LED strips 10 to be easily dissipated away from the strips. Central cavity 85 runs the length of structure 13 and serves as a conduit for electrical wiring to or from each endcap 15. As explained below, central cavity 85 is also shaped to receive an electrical voltage regulator 90 which includes a circuit board 95. Further, structure 13 includes four inward facing C-shaped channels 100 proximate outer corners 50. The ends of channels 100 serve as receivers for the threaded fasteners that secure endcaps 15 to structure 13.

FIG. 5 shows a cross section for an alternate embodiment of structure 13, which presents a mounting surface for LED strips 10 to be mounted on four sides of the structure 13. The alternate embodiment of structure 13 is essentially the same shape as the two-sided version of the structure except that outer wall 75 is absent. Because outer wall 75 is gone, the alternate embodiment of structure 13 has two additional channels 35 on the sides of the structure where LED strips 10 may be mounted.

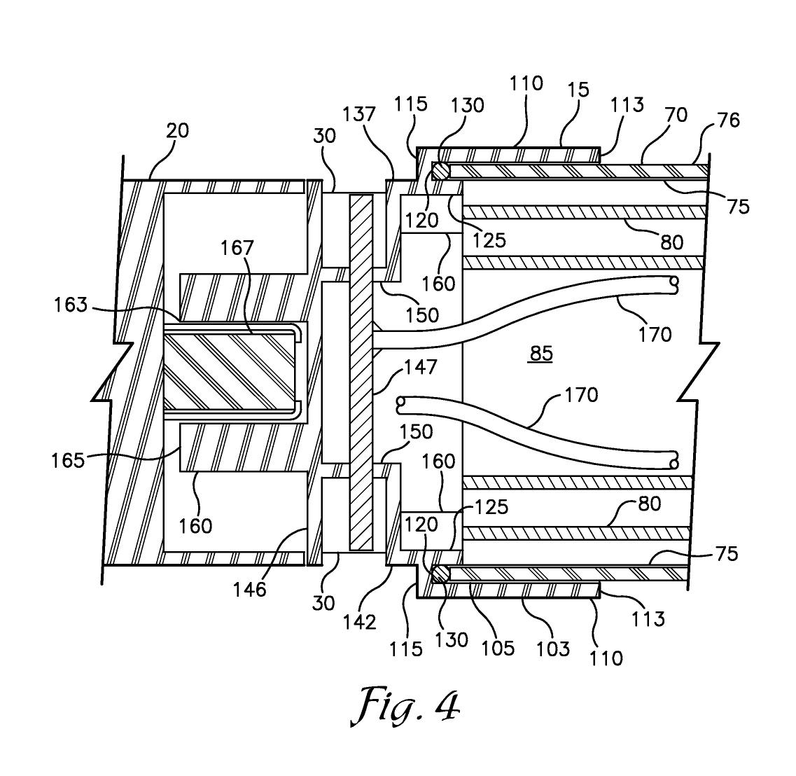

Attached to each end of structure 13 is an endcap 15. As shown in FIGS. 2 and 4, each endcap 15 is generally cylindrical and the body of the endcap has a multi-level or graduated shape. Endcap 15 has a hollow interior to allow the ends of structure 13 and shell 70 to be partially located therein. Endcap 15 has a first level or segment 103 that forms a circular socket 105 for receiving an end of shell 70. The first level 103 comprises an annular or generally circular curved wall 110 extending from a rim 113 to a ledge 115. Socket 105 has a circumferential groove 120 around the interior of wall 110. Groove 120 is formed on the underside of ledge 115 and has a lip 125 spaced inward from wall 110. A flexible seal or gasket 130 is located in groove 120 between lip 125 and wall 110. When bulb 5 is assembled, an end of shell 70 is received within groove 105 such that the end portion of shell wall 76 is encircled by wall 110 and the shell wall 76 is positioned partially in groove 120. Wall 76 presses against gasket 130 to maintain a generally watertight seal between endcap 15 and shell 70.

Endcap 15 has a second level or segment 137 adjacent the first level 103. The second level 137 is slightly smaller in diameter than first level 103. The difference in the diameters results in a ledge 115 around the base of second level 137. Second level 137 includes an annular or generally circular curved wall 142 extending upward from ledge 115 to a circular cap 146. Annular wall 142 is smaller in diameter than annular wall 110 of the first level. It is understood that walls 110 and 142 may be shapes other than generally circular. Walls 110 and 142 could have straight segments instead of being curved and could encircle the hollow interior of endcap 15 in a rectangular or polygonal fashion. Accordingly, cap 146 may be a shape other than circular. Walls 110 and 142 may not be similar shapes.

Electrical power sockets 30 are formed in wall 142 on opposing sides of the second level 137. Each socket 30 has a generally trapezoid shaped cross section and is recessed into second level 137. Two rigid electrical conductors 147 (see FIG. 7) extend into each socket 30. One of the conductors is a positive conductor 148 which allows electricity to be supplied to the LED strips 10, and the other conductor is a negative conductor 149 which completes the electrical circuit. The conductors 147 run from one socket 30 to another. The conductors 147 extend into a first socket 30, then pass through the back wall 150 of the first socket, then across the interior space under cap 146, then through the back wall 150 of a second socket and into the second socket 30.

The second level 137 also comprises four fastener holes 157 located near wall 142 and adjacent the sides of sockets 30. Each hole 157 extends into a boss 160. Each boss 160 is integrally formed with annular wall 142 and the structure of the boss partially protrudes into the interior space under cap 146. The fastener holes 157 are located on endcap 15 such that they align with channels 100 on structure 13 when endcap 15 and structure 13 are fastened together (see FIG. 3). Threaded fasteners (not shown) are inserted into the holes 157 and screwed into channels 100 to attach the endcap 15 to structure 13. After the fasteners are installed, plugs (not shown) may be inserted in each hole 157 to cover the fasteners.

Integrally attached to cap 146 is a bulb support 160. Bulb support 160 projects away from cap 146 and has an oblong or oval shaped cross section. Support 160 includes a rectangular recess 163 formed in the distal end 165 of support 160 and extending through the support to the cap 146. Recess 163 is sized to receive a protrusion 167 from an RDC light socket 20. As disclosed above, socket 20 may or may not be electrified. Bulb 5 does not receive electrical power from socket 20, thus it is preferable that bulb support 160 be made from a non-electrically conductive material such as plastic.

As shown in FIG. 7, bulb 5 comprises an electrical system that regulates the voltage of electricity being delivered to LED strips 10 as well as additional bulbs that might be connected to bulb 5. Each conductor 147 has an electrical lead 170 coupled or attached thereto. One of the leads is a positive lead 172 which is connected to the positive conductor 148, and the other lead is the negative lead 173 which is connected to the negative conductor 149. Generally, the leads 170 are soldered to the conductors 147 but other methods of forming an electrical connection may be used. Both leads are connected to a voltage regulator 90. There are numerous types of voltage regulators known in the industry that may be used. The voltage regulator 90 in the present embodiment comprises an operational amplifier and a metal oxide semiconductor field effect transistor (MOSFET) to improve stability of the regulated voltage. The voltage regulator 90 is preferably sized to fit within central cavity 85 (see FIG. 2). Locating the voltage regulator 90 in cavity 85 ensures it will not block any light from the LED strips 10 and wiring to and from the regulator is easily routed through central cavity 85. Voltage regulator 90 is wrapped in an electrically insulating material (not shown) prior to being inserted in the central cavity 85. It is foreseen that the voltage regulator 90 could also be located in other areas of bulb 5 depending on the shape and configuration of the regulator.

Bulb 5 has two endcaps 15 and each endcap has a positive lead 172 and negative lead 173 attached to the endcap's conductors 147 as described above. As shown in FIG. 7, the leads from each endcap 15 connect to the voltage regulator 90. The positive leads 172 from both endcaps 15 connect to the regulator 90 at a common connection point 193. Thus, the voltage of the positive conductors 148 in both endcaps 15 will always be the same. Conversely, the negative leads 173 from each endcap 15 connect to the voltage regulator 90 at different locations. Because the negative leads 173 associated with each endcap 15 are partitioned by the voltage regulator 90, the negative conductors 149 in each cap may be at different voltages.

Each LED strip 10 has a positive wire 190 and negative wire 195 to deliver electricity to its respective LEDs 8 (see FIG. 7). The electricity flowing to the LED strips 10 is regulated by the voltage regulator 90. Multiple LED strips 10 may be connected in parallel downstream of the voltage regulator 90. The positive wire 190 from a first LED strip 10 connects to the common electrical connection point 193, and the negative wire 195 from the first LED strip 10 connects to the voltage regulator 90. The positive wire 190 is coupled to the positive leads 172 because they are all connected to the common connection point 193. Additional LED strips 10 may be connected in parallel with the first LED strip 10 by connecting positive wires 190 and negative wires 195 from each additional LED strip 10 to the respective positive wire 190 and negative wire 195 from the first LED strip 10. The voltage regulator 90 is intended to supply a relatively constant voltage regardless of the number of LED strips 10 connected to it. The wiring configuration described above may differ depending on the voltage regulator used.

Bulb 5 may be installed in a pair of opposing RDC light sockets 20 spaced at a distance to accommodate the length of bulb 5. Bulb 5 may be almost any length but four feet is standard. Each RDC light socket 20 has a retractable spring loaded protrusion 167 to support the bulb being installed. The first end of bulb 5 may be aligned with one of the light sockets 20 such that the bulb support 160 on endcap 15 is near the protrusion 167 on the socket. The protrusion 167 is placed all the way into the recess 163 in bulb support 160. Next, the protrusion 167 on the second light socket 20 is placed in a retracted position. The second end of bulb 5 is aligned with the second light socket 20 such that the bulb support 160 on the second endcap 15 is near the protrusion 167 on the second socket 20. The second protrusion 167 extends into the recess 163 on the second endcap 15 so that bulb 5 is supported at both ends.

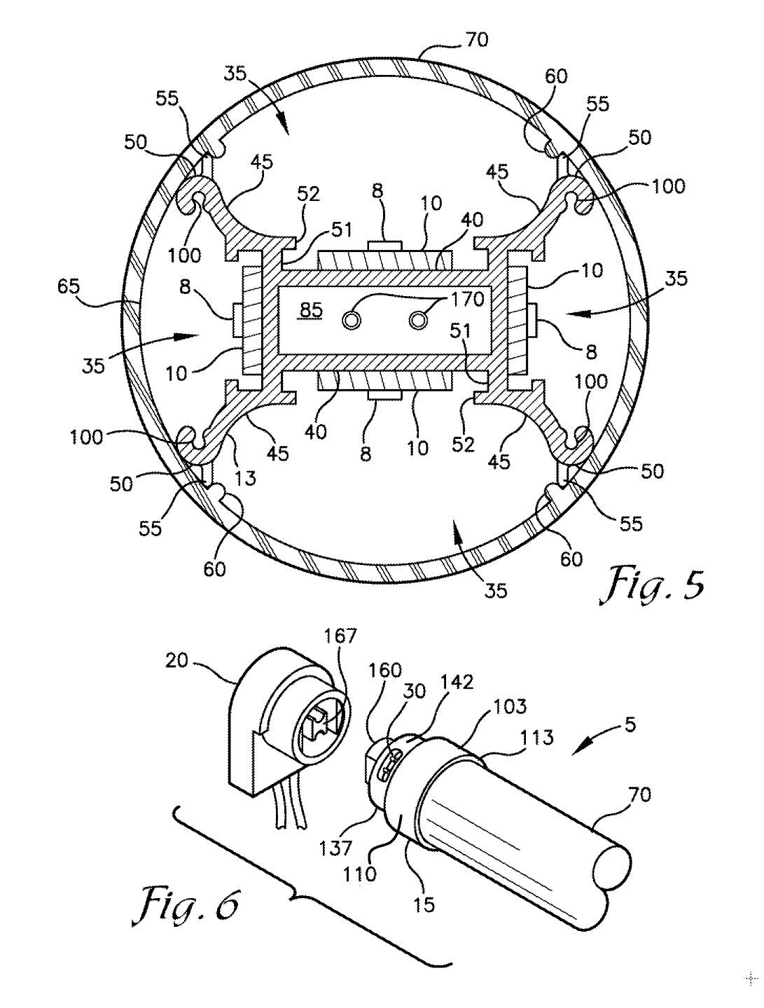

Bulb 5 is powered by low voltage direct current electricity supplied by a power pack 196. The power pack 196 could be a battery or a converter and transformer connected to an alternating current circuit. Both types of power packs are well known in the industry and readily available. Electricity is supplied to bulb 5 through a power supply plug 25 which is connected to the power pack 196 by electrical wiring. Plug 25 is sized and shaped to approximate the trapezoidal shape of the power sockets 30 in endcaps 15 (see FIG. 6). Because the power supply plug 25 and power socket 30 are trapezoidal, they can only be connected one way which ensures electrical polarity is correct. The power supply plug 25 slides into a power socket 30 to frictionally engage the sides of the socket 30 which secures the plug in the socket. The electrical conductors 147 extending into the socket 30 are received into the power supply plug 25 to make electrical contact with wiring in the plug. Electricity then flows from the power pack 196 through the power supply plug 25 to the bulb 5 to activate LEDs 8. It does not matter which power socket 30 on bulb 5 is used for plug 25.

A connector cable 197 may be used to connect additional bulbs 5 to the original bulb 5. The connector cable 197 comprises wiring 199 having power supply plugs 25 attached at each end. The first supply plug 25 on cable 197 may be plugged into any available power socket 30 on the original bulb 5 (which is receiving power from power pack 196) and the second supply plug 25 on cable 197 may be plugged into a power socket 30 on a second bulb 5. Both bulbs 5 may be powered by a single power pack 196. Additional bulbs 5 may be connected to either the original bulb 5 or any bulb 5 receiving power through the original bulb. The voltage regulator 90 ensures that the voltage of the electricity being supplied to additional bulbs 5 remains relatively constant regardless of the number of additional bulbs being powered.

Having thus described the invention, what is claimed as new and desired to be secured by this Patent is as follows:

1. A light bulb comprising:
an elongated structure having at least one longitudinal side;
a plurality of light emitting diodes secured to said at least one longitudinal side, said light emitting diodes arranged in a generally linear configuration;
a tubular shell having a wall surrounding an interior void, said elongated structure positioned at least partially in said interior void;
an endcap covering an end of said tubular shell, said endcap having a support member adapted to engage a recessed double contact light bulb socket, said endcap having a pair of electrical conductors extending into a socket formed in said endcap, said socket adapted to receive a power supply plug; and
a pair of electrical leads coupled to said pair of electrical conductors, and said light emitting diodes having wiring coupled to at least one of said electrical leads.

2. The light bulb as in claim 1 wherein light emitting diodes are secured to opposite sides of said elongated structure.

3. The light bulb as in claim 2 further comprising a longitudinal cavity formed in said elongated structure between said opposite sides of said elongated structure.

4. The light bulb as in claim 3 wherein said electrical leads are routed through said longitudinal cavity.

5. The light bulb as in claim 4 further comprising a voltage regulator for regulating the voltage of electricity to said light emitting diodes.

6. The light bulb as in claim 5 wherein said voltage regulator is located at least partially in said longitudinal cavity.

7. A light bulb comprising:
an elongated structure having a plurality of light emitting diodes secured thereto;
a tubular shell having a wall at least partially surrounding said elongated structure;
an endcap including:
a body having a first segment adjacent a second segment, said first segment comprising a wall around a first interior cavity and said second segment comprising a wall around a second interior cavity;
a groove for receiving an end of said tubular shell, said groove located between said first interior cavity and said wall of said first segment;
a pair of electrical conductors extending through said second interior cavity and into a socket formed in said second segment, said socket adapted to receive a power supply plug; and
a support member adapted to engage a recessed double contact light bulb socket, said support member extending away from said body and having a generally rectangular recess formed in a distal end of said support member for receiving a protrusion from a recessed double contact light socket.

8. The light bulb as in claim 7 further comprising a longitudinal cavity formed in said elongated structure.

9. The light bulb as in claim 8 further comprising a voltage regulator for regulating the voltage of electricity powering said plurality of light emitting diodes.

10. The light bulb as in claim 9 wherein said voltage regulator is located at least partially in said longitudinal cavity.

11. A light bulb comprising:
an elongated structure having light emitting diodes secured to at least one of its longitudinal sides, said light emitting diodes arranged in a generally linear configuration;
a translucent tubular shell having a wall surrounding an interior void, said elongated structure positioned at least partially in said interior void;
an endcap including:
a body having a first cylindrical segment adjacent a second cylindrical segment, said first cylindrical segment comprising a wall encircling a first interior cavity and said second cylindrical segment comprising a wall encircling a second interior cavity, said first cylindrical segment having a diameter that is greater than said second cylindrical segment;
a groove for receiving an end of said tubular shell, said groove located between said first interior cavity and said wall of said first cylindrical segment;
a pair of electrical conductors extending through said second interior cavity and into a socket formed in said second cylindrical segment, said socket adapted to receive a power supply plug; and
a support member adapted to engage a recessed double contact light bulb socket, said support member extending away from said body and having a generally rectangular recess formed in a distal end of said support member for receiving a protrusion from a recessed double contact light socket; and
a pair of electrical leads coupled to said pair of electrical conductors, said light emitting diodes receiving electricity through at least one of said electrical leads.

12. The light bulb as in claim 11 wherein light emitting diodes are secured to opposite sides of said elongated structure.

13. The light bulb as in claim 12 further comprising a longitudinal cavity formed in said elongated structure between said opposite sides of said elongated structure.

14. The light bulb as in claim 13 wherein said electrical leads are routed through said longitudinal cavity.

15. The light bulb as in claim 14 further comprising a voltage regulator for regulating the voltage of said electricity to said light emitting diodes.

16. The light bulb as in claim 15 wherein said voltage regulator is located at least partially in said longitudinal cavity.
